(19) United States
(12) Patent Application Publication
(10) Pub. No.: US 2013/0099458 A1
(43) Pub. Date: Apr. 25, 2013

(54) Nail tech./manicurist mobile cart

(71) Applicant: Robin Lee Ryan, Port Orange, FL (US)

(72) Inventor: Robin Lee Ryan, Port Orange, FL (US)

(21) Appl. No.: 13/317,541

(22) Filed: Oct. 21, 2011

(51) Int. Cl. B62B 1/00

(52) U.S. Cl. 280/47.131

(57) ABSTRACT

A lockable nail supplies cart for use in beauty/nail salons. Includes lockable double doors that are hinged at the sides to move from a horizontally aligned closed position, behind the doors are drawers for storing nail/manicuring supplies.

### FIELD OF THE INVENTION

The present invention relates to a nail technician mobile cart for organizing and storing manicuring tools and other nail tech. supplies.

### BACKGROUND OF THE INVENTION

This invention relates generally to portable trolleys or carts for the traveling nail technicians to carry their supplies such as; acrylic powders, gels, files, e-files, polishes, polish remover etc. . . . Everything that a nail technician/manicurist would need for their profession.

The need to organize and store such items between uses has led to the development of some generic storage containers, none of the presently-available storage options succeed in organizing all the items one needs to perform their job in the nail tech./manicurist industry.

A large number of different types of wheeled trolley or carts have been suggested in the past but none for the nail technicians.

The primary object is to have a rolling, lockable trolley or cart of light weight construction for the use in beauty/nail salons or the traveling nail technician.

### SUMMARY OF THE INVENTION

The present invention provides storage and organizing of implements, nail/artist brushes, bottles, jars, polishes, lotions, scrubs and other miscellaneous items.

The nail/manicure mobile cart may be a lockable supply cart of the present invention, eliminates the disadvantages of prior cart enclosures of this nature by providing the front of the cart with double door(s) that open and attach to the sides of the cart, with two storage shelves on the inside of each door that can support cans, bottles, etc. . . .

The interior of the cart has sliding drawers for more storage of supplies. The drawers having varying depths provide many different options for organizing and storage of items, dividers can be added for improved organization. It is an object of the present invention to provide a nail/manicure mobile cart that can be easily be wheeled from one location to another.

When closing the door(s) on the nail/manicure mobile cart can be secured by a single key-operated lock so as to prevent loss of drawer contents.

The nail/manicure mobile cart can be provided with an adjustable handle an swivel wheels easy positioning with in the nail technician operators area of the shop.

### BRIEF DESCRIPTION OF THE DRAWINGS

The accompanying drawings will illustrate the embodiment of the present invention and together with the description, serve to explain the principles of the invention, in the drawings:

FIG. 1 Shows the invention;

FIG. 2 Shows all the compartments of the invention;

FIG. 3 Shows a front view with door(s) open to show inside view of the invention;

FIG. 4 Shows a cut away side view of the invention;

FIG. 5 Shows the drawers with adjustable dividers, one variation of how the dividers can be;

### DETAILED DESCRIPTION OF THE INVENTION

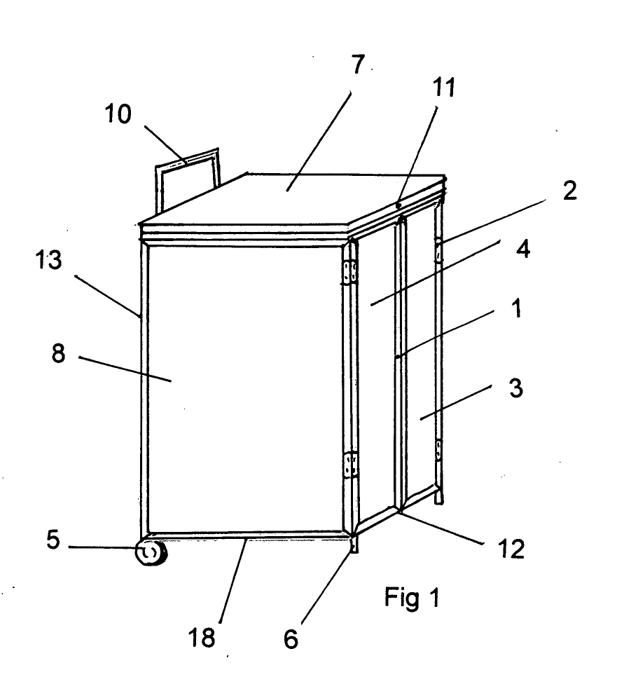

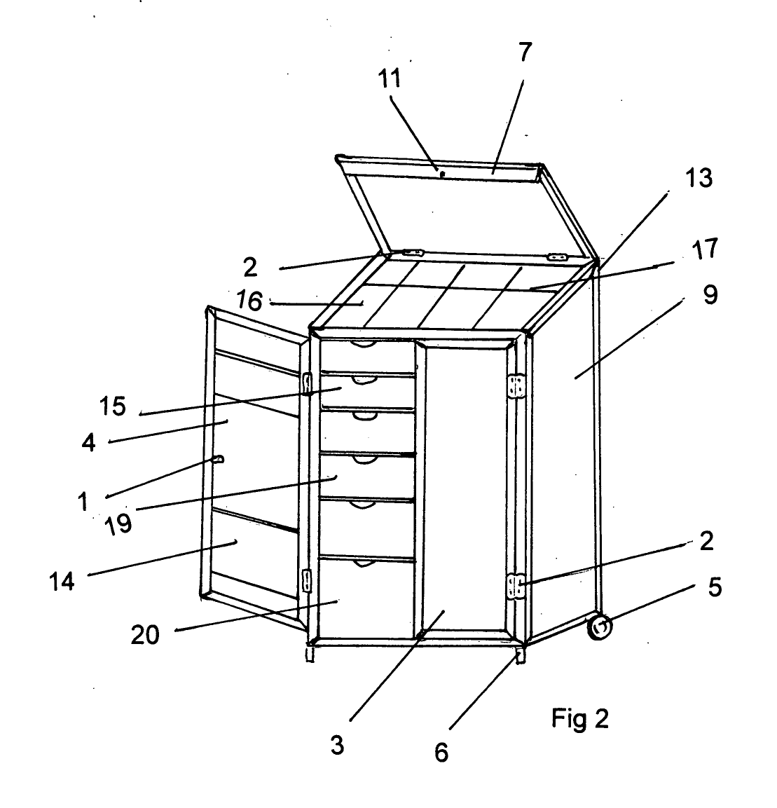

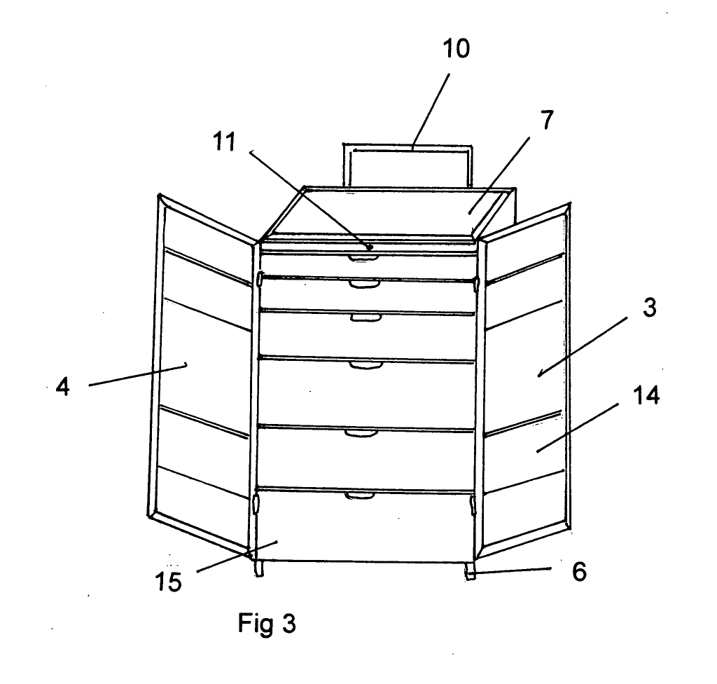

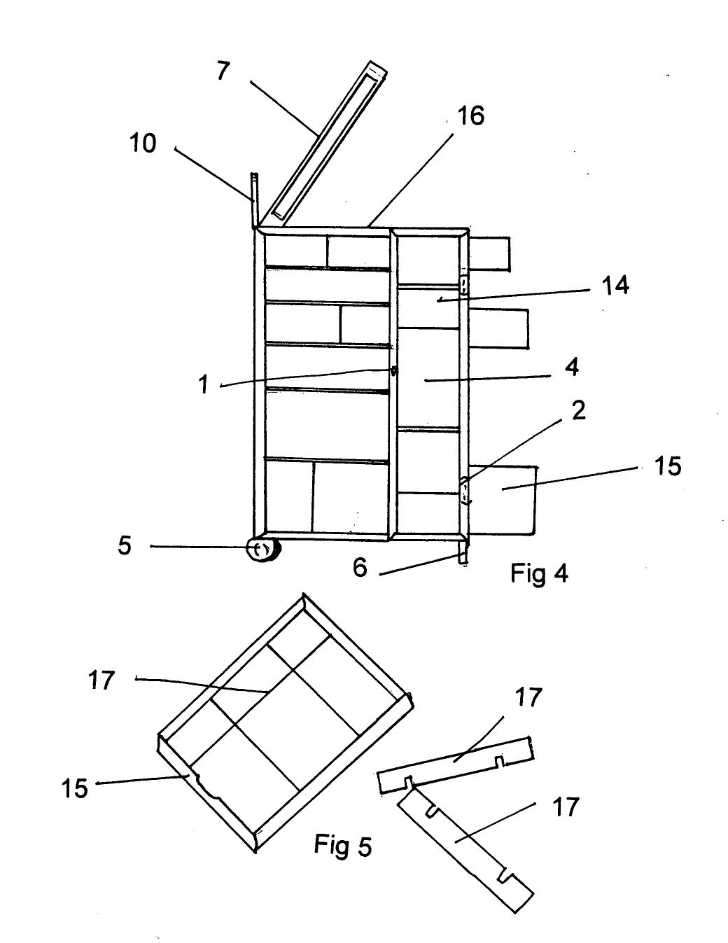

Referring to the drawings, a lockable nail tech/manicurist mobile supply cart. Embodying the present invention includes an up right, rectangular housing having castor wheels 5 and front legs 6 to stay stationary when not being mobile. The front of the housing has a door(s) 3,4 these door(s) may be adapted to be locked 1 in their closed position of FIG. 1, and to be moved to an open position in FIG. 2,3 to permit easy access to the interior of the housing.

The housing includes side walls 8,9 top 7,16 of housing which may have a lockable compartment in which to keep money, valuables or other supplies. Bottom 19 and rear wall 13 these walls are of solid configuration, could be made of stainless steel or other heavy-duty material. The size of the nail/manicure mobile cart could be made of various heights and widths. The door(s) 3,4 being of any width with shelving for storage.

The drawers 15,19,20 having several different sizes of depth and having adjustable dividers 17, top of the nail/manicure mobile cart 7 which may be also be lockable 11 and may be of different depths in size with adjustable dividers 17. The door(s) 3,4 and top 7 have hinges 2 for opening and closing. FIG. 5 is a drawer 15 showing the adjustable dividers. There is also an adjustable handle 10 on the back side 13 of the nail/manicure cart for easy mobility.

7 The nail/manicure mobile cart of claim 3 all drawers are able to slide in and out along guided rails.

I claim:

1. A portable/mobile cart for use in a beauty/nail salon/spa or the traveling nail tech. for transporting articles form place to place.

2. The nail/manicure mobile cart of claim 1 wherein the shroud could be made using an aluminum finish or vinyl wrapped wood with chrome trim on the inside, steel reinforced on the outside.

3. The nail/manicure mobile cart of claim 1 which further includes (which could be adjustable) dividers in each drawer.

4. The nail/manicure mobile cart of claim 1 wherein the top surface can open and which may be lockable with adjustable dividers.

5. The nail/manicure mobile cart of claim 1 has a solid left side, a solid right side and a solid back side, a bottom and (which may be lockable) double door(s) in the front of the nail/manicure mobile cart.

6. The nail/manicure mobile cart of claim 5 the double door(s) having storage compartments on the inside of both doors.

7. The nail/manicure mobile cart of claim 3 all drawers are able to slide in and out along guided rails.
